(19) United States
(12) Patent Application Publication
(10) Pub. No.: US 2008/0261020 A1
(43) Pub. Date: Oct. 23, 2008

(54) Adhesive layer for resin and a method of producing a laminate including the adhesive layer

(75) Inventors: Mutsuyuki Kawaguchi, Hyogo (JP); Satoshi Saitou, Hyogo (JP); Masashi Deguchi, Hyogo (JP); Tsuyoshi Amatani, Hyogo (JP)

Correspondence Address: HAMRE, SCHUMANN, MUELLER & LARSON, P.C., P.O. BOX 2902, MINNEAPOLIS, MN, 55402-0902, US

(73) Assignee: MEC COMPANY LTD., HYOGO (JP)

(21) Appl. No.: 11/904,435

(22) Filed: Sep. 27, 2007

(30) Foreign Application Priority Data
Sep. 27, 2006 (JP) 2006-262895

(51) Int. Cl. B32B 15/08; B32B 3/26

(52) U.S. Cl. 428/319.1; 156/62.2

(57) ABSTRACT

An adhesive layer for resin according to the present invention is formed of copper or a copper alloy for adhering a resin to a layer of copper or a copper alloy. The adhesive layer is formed of a metal layer of a coralloid structure made of an aggregation of a number of particles of copper or a copper alloy with gaps between the particles, and a plurality of micropores are present on the surface. The micropores have an average diameter in a range of 10 nm to 200 nm, and at least two micropores in average are present per 1 μm² of the metal layer surface. Thereby, sufficient adhesion between the resin and the copper or copper alloy is provided. This serves to prevent ion migration caused by dendrites, which has been a problem in a conventional layer of tin or a tin alloy, and the adhesion to a resin having a high-glass transition temperature (Tg) is improved as well. The present invention also provides a method of producing a laminate including the adhesive layer.

### BACKGROUND OF THE INVENTION

1. Field of the Invention

The present invention relates to an adhesive layer for resin, which is used for adhering a resin and a layer of copper or a copper alloy, and a laminate including the adhesive layer. More specifically, the present invention relates to an adhesive layer for resin, which has a copper surface and which can be used for various electronic components such as a printed circuit board, a semiconductor-mount component, a liquid crystal device, and an electroluminescent element; and a method of producing a laminate including the adhesive layer.

2. Description of Related Art

In general, a multilayer printed circuit board is produced by laminating and pressing an inner substrate having a conductive layer of copper on the surface, with other inner substrate(s) and/or copper foil(s) via pre-preg. The conductive layers are connected electrically by an open hole called a through-hole having a copper-plated wall. On the copper surface of the inner substrate, needle-like copper oxide called “black oxide” or “brown oxide” is formed to improve the adhesion to the pre-preg. In this method, the needle-like copper oxide encroaches into the pre-preg so as to provide an anchoring effect for improving the adhesion.

The copper oxide has excellent adhesion to the pre-preg. However, when contacted with an acidic solution in a step of plating the through-hole, the copper oxide will be dissolved to change its color, and it causes easily a defect called haloing.

Therefore, for example, each of Patent documents 1 and 2 below suggests a technique for forming a tin layer, in place of the black oxide or the brown oxide, on the copper surface of the inner substrate. Patent document 3 suggests plating a copper surface with tin and further treating with a silane compound in order to improve the adhesion between copper and resin.

Patent document 4 suggests formation of a copper-tin alloy layer on a copper surface in order to improve the adhesion between copper and resin. It also suggests roughening the copper surface by etching so as to develop an anchoring effect.

[Patent document 1] EPC 0 216 531 A1

[Patent document 2] JP H04-233793 A

[Patent document 3] JP H01-109796 A

[Patent document 4] JP 2000-340948 A

However, in the method of forming a normal tin layer or a copper-tin alloy layer on a copper surface as described in Patent documents 1 and 2, ion migration due to the dendrites may occur.

Moreover, when the tin layer or the copper-tin alloy layer is used, the effect of improving the adhesion varies depending on the type of the resin. Particularly, when a hard resin with a high glass transition temperature is used, the effect of improving the adhesion may be insufficient.

In the method as described in Patent document 3, the copper is eluted into the plating solution due to the tin plating, and this decreases the diameter of the wirings.

Even when the surface of the normal tin or tin alloy layer as described in Patent documents 1, 2 and 4 is treated with silane, the adhesion with resin will not reach a satisfactory level. Particularly, under a severe condition such as high temperature, high humidity and high pressure, adhesion to the resin can be insufficient sometimes.

### SUMMARY OF THE INVENTION

Therefore, with the foregoing in mind, it is an object of the present invention to provide an adhesive layer for resin, which can provide sufficient adhesion between resin and copper or a copper alloy. Ion migration caused by dendrites has been a problem in a conventional layer of tin or a tin alloy, but the adhesive layer of the present invention does not cause the problem of ion migration. The adhesive layer also serves to improve the adhesion to a resin having a high glass transition point (Tg). The present invention provides also a method of producing a laminate including the adhesive layer.

An adhesive layer for resin according to the present invention is formed of copper or a copper alloy in order to adhere a resin and a layer of copper or a copper alloy, wherein the adhesive layer is formed of a metal layer having a coralloid structure made of an aggregation of a number of particles of copper or a copper alloy with gaps between the particles, and a plurality of micropores are present on the surface. The average diameter of the micropores is in a range of 10 nm to 200 nm, and at least two micropores are present in average per 1 μm² of the metal layer surface.

A method of producing a laminate according to the present invention includes steps of forming a metal layer of a coralloid structure made of an aggregation of a number of particles of copper or copper alloy with gaps between the particles, and a plurality of micropores are present on the surface, and the micropores have an average diameter in a range of 10 nm to 200 nm, and at least two micropores are present in average per 1 μm² of the metal layer surface; and laminating a layer of copper or a copper alloy with a resin layer via the metal layer.

### BRIEF DESCRIPTION OF THE DRAWINGS

FIG. 1 is a microphotograph of a metal layer surface according to Example 1 of the present invention, which is taken with an FE-SEM (×100,000).

FIG. 2 is a microphotograph of a cross section of the metal layer, which is taken with an FE-SEM (×20,000).

FIG. 3 is a graph showing a metal abundance analyzed with an X-ray photoelectron spectroscopy (XPS) in the depth direction of the metal layer obtained in Example 1 of the present invention, from the surface layer to the position after Ar-sputtering for 60 seconds.

FIG. 4 is a graph showing a metal abundance analyzed with an XPS in the depth direction of the metal layer obtained in Conventional example 1, from the surface layer to the position after Ar-sputtering for 60 seconds.

### DETAILED DESCRIPTION OF THE INVENTION

Since the adhesive layer for resin according to the present invention is a layer of copper or a copper alloy having a special coralloid structure that is not available in the case of a conventional layer of tin or a tin alloy, sufficient adhesion between the resin and the copper or the copper alloy can be obtained. The adhesive layer can be used suitably for a copper wiring to transmit a high-frequency current, since the adhesive layer is free from ion migration caused by dendrites, which has been a problem in a conventional layer of tin or a tin alloy. Though a conventional layer of tin or a tin alloy cannot provide sufficient adhesion to a high-Tg resin, the adhesive layer of the present invention can improve its adhesion even with such a high-Tg resin.

The adhesive layer for resin according to the present invention is an adhesive layer formed of copper or a copper alloy so as to adhere a resin and a layer of copper or a copper alloy. The adhesive layer is formed of a metal layer of a coralloid structure made of an aggregation of a number of particles of copper or a copper alloy with gaps between the particles, and a plurality of micropores are present on the surface. The average diameter of the micropores is in a range of 10 nm to 200 nm, and at least two micropores are present per 1 μm² on the metal layer surface. The adhesion to the resin can be improved due to the metal layer of the special coralloid structure as mentioned above. In this specification, the “coralloid structure” indicates a porous structure, which is shown specifically in FIG. 1.

When there are too many micropores and the diameter is too large, the relative roughness of the metal surface is increased. When the metal surface is provided on a copper wiring, especially a copper wiring to transmit a high-frequency current, a skin effect causes a transmission loss that causes a signal attenuation, and it is not preferable. When the number of the micropores is too small and the diameter is too small, the adhesion to the resin cannot be maintained. In this regard, it is preferable that the average diameter of the micropores is in a range of 10 nm to 200 nm, and the number of the micropores is not less than 2 per 1 μm², preferably about 8 to about 15 per 1 μm². A metal layer having micropores within the above-mentioned ranges has a preferable adhesion, and it can be used suitably for a copper wiring for transmitting a high-frequency current.

Alternatively, the metal layer can contain tin. Namely, when the metal layer contains a small amount of tin in the surface layer portion only and the deep layer portion is copper-rich, the adhesion can be improved further in comparison with the conventional layer of tin or a tin alloy, and at the same time, ion migration can be prevented.

It is preferable in the present invention that a silane compound binds through reaction to the surface of the metal layer to be adhered to resin, so that the adhesion to the resin can be improved further.

It is preferable that the metal layer is made of a copper alloy containing tin in a range of more than 0 wt % and not more than 3 wt %. The tin content denotes an amount of tin contained in the whole layer (for example, a metal layer having a thickness of about 0.5 μm), and the content is preferably not more than 3 wt %, more preferably not more than 1 wt %. It is preferable that tin is concentrated in the vicinity of the uppermost surface of the layer, while the bottom layer contains copper alone and substantially no tin is present there. Here, the “uppermost surface of the layer” indicates a region from the uppermost surface (from the surface to the several nanometers deep) to a position about 30-50 nm deep in the layer. The “bottom layer” indicates the position at least 0.5 μm deep in the layer.

The tin present in the vicinity of the uppermost surface is not pure, but all tin exists as an alloy with copper or oxide thereof.

In this manner, since a small amount of tin alloy or oxide of tin is contained in the vicinity of the uppermost surface, the adhesion to the resin is improved, and at the same time, problems such as ion migration in the conventional tin-plated layer can be prevented.

It is preferable that the tin is contained more in the surface layer portion of the metal layer than in the inner layer portion. More specifically, at a position subjected to Ar-sputtering for 0 to 10 seconds, the tin rate is not more than 60 atomic %. It is preferable that at a position subjected to the Ar-sputtering for more than 10 seconds, the copper rate is not less than 50 atomic %. Here, the Ar-sputtering is carried out (acceleration voltage: 5 KV) by using a high-speed etching ion gun (XPS JPS-9010MC manufactured by Japan Electron Optics Laboratory Co. Ltd.), and the compositions are analyzed at regular intervals during the Ar-sputtering, thereby measuring the composition change in the depth direction of the film. An SiO₂ etching speed under the same condition is 20 nm/min. In 60 seconds of Ar-sputtering under the above-mentioned condition, the metal layer is sputtered to a depth of about 40 nm.

It is preferable that the thickness of the metal layer is not less than 20 nm and not more than 1 μm.

The method of producing the adhesive layer for resin according to the present invention is not limited particularly, but for example, it can be formed by contacting an aqueous solution containing the ingredients below with copper or a copper alloy:
(1) acid;
(2) tin salt or tin oxide;
(3) salt or oxide of at least one metal selected from the group consisting of silver, zinc, aluminum, titanium, bismuth, chromium, iron, cobalt, nickel, palladium, gold and platinum;
(4) reaction accelerator;
(5) diffusion system retaining solvent; and
(6) copper salt.

1. Acid

An acid is blended to adjust the pH in accordance with the type of the tin salt and to provide a surface with excellent adhesion. Examples of the acid applicable in the present invention include: inorganic acids such as hydrochloric acid, sulfuric acid, nitric acid, fluoroboric acid, and phosphoric acid; and water-soluble organic acids, which include: carboxylic acids such as formic acid, acetic acid, propionic acid, and butyric acid; alkanesulfonic acids such as methanesulfonic acid and ethanesulfonic acid; and aromatic sulfonic acids such as benzenesulfonic acid, phenolsulfonic acid, and cresolsulfonic acid. Among these examples, sulfuric acid or hydrochloric acid is preferred in view of some points such as the speed of forming the adhesive layer, and solubility of a compound of metal such as tin and copper. The preferred concentration of the acid is 0.1 to 50 wt %, more preferably 1 to 30 wt %, and particularly preferably 1 to 20 wt %. When the concentration exceeds 50 wt %, the adhesion to resin will deteriorate. When the concentration is less than 0.1 wt %, the area of the copper that can be treated with a certain amount of solution will be reduced considerably.

2. Tin Salt or Tin Oxide

Any tin salts can be used without any particular limitation as long as it is soluble, but salts of the above-mentioned acids are preferred in view of the solubility. Examples of the applicable tin salts include stannous salts and stannic salts, specifically, stannous sulfate, stannic sulfate, stannous borofluoride, stannous fluoride, stannic fluoride, stannous nitrate, stannic nitrate, stannous chloride, stannic chloride, stannous formate, stannic formate, stannous acetate, and stannic acetate. A stannous salt is preferred in view of the speedy formation of the adhesive layer, and a stannic salt is preferred in view of the stability in the solution. Among the tin oxides, stannous oxide is preferred.

It is preferable that the concentration of the tin salt or the tin oxide is in a range of 0.05 to 10 wt % in terms of tin, and more preferably, 0.1 to 5 wt %, and particularly preferably, 0.5 to 3 wt %. When the concentration exceeds 10 wt %, the adhesion to resin will deteriorate. When the concentration is less than 0.05 wt %, formation of the adhesive layer will be difficult.

3. Salt or Oxide of Metal

For the salt or oxide of metal, at least one metal selected from the group consisting of silver, zinc, aluminum, titanium, bismuth, chromium, iron, cobalt, nickel, palladium, gold and platinum, is used.

These metals are considered to serve to improve remarkably the adhesion between the copper and the resin, and at the same time, acting on the surface of copper or the copper alloy so as to form gaps and micropores in/on the copper or a copper alloy. These metals act easily on copper and can be handled in a simple manner. These metals can be used without any particular limitations as long as they are soluble as salts or oxides of the metals, and there is no particular limitation on the valences of the metals.

The examples include: oxides such as Ag₂O, ZnO, Al₂O₃, TiO₂, Bi₂O₃, and Cr₂O₃; halogenides such as AgCl, ZnCl₂, TiCl₃, CoCl₂, FeCl₃, PdCl₂, AuCl, ZnI₂, AlBr₃, ZnBr₂, NiBr₂, and BiI₃; salts with inorganic acids such as Ag₂SO₄, NiSO₄, CoSO₄, Zn(NO₃)₂, and Al(NO₃)₃; and salts with organic acids such as CH₃COOAg, and (HCOO)₂Zn. The preferred concentration of the metal salt or metal oxide is in a range of 0.1 to 20 wt % in terms of metal, and more preferably, 0.5 to 10 wt %, and particularly preferably 1 to 5 wt %. When the concentration exceeds 20 wt % or when it is less than 0.1 wt %, the adhesion to resin will deteriorate.

4. Reaction Accelerator

A reaction accelerator will form a chelate in coordination with copper in the base so as to facilitate formation of an adhesive layer for resin on the copper surface. The examples include thiourea and thiourea derivatives such as 1,3-dimethyl thiourea, 1,3-diethyl-2-thiourea, and thioglycolic acid. The preferred concentration of the reaction accelerator is in a range of 1 to 50 wt %, more preferably 5 to 40 wt %, and particularly preferably 10 to 30 wt %. When the concentration of the reaction accelerator exceeds 50 wt %, the adhesion to resin will deteriorate. When the concentration is less than 1 wt %, formation of the adhesive layer will be delayed.

5. Diffusion System Retaining Solvent

The diffusion system retaining solvent in the present specification denotes a solvent for retaining the concentration of the reactive component, which is required for forming the adhesive layer, in the vicinity of the copper layer surface. Examples of the diffusion system retaining solvent include: glycols such as ethylene glycol, diethylene glycol, and propylene glycol; and glycol esters such as cellosolve, carbitol, and butyl carbitol. The preferred concentration of the diffusion system retaining solvent is in a range of 1 to 80 wt %, more preferably 5 to 60 wt %, and particularly preferably 10 to 50 wt %. When the concentration exceeds 80 wt %, the adhesion to resin will deteriorate. When the concentration is less than 1 wt %, formation of the adhesive layer will be difficult, and the stability of the metal compound in the solution will deteriorate considerably.

6. Copper Salt

Copper salts such as CuSO₄ and CuCl₂ can be added as well. As a result of addition of the copper salt, the copper concentration in the solution is increased and it will help formation of a metal layer having a high adhesion to resin as described in the present specification.

The preferred concentration of the copper salt is within a range of 0.01 to 10 wt % in terms of copper, more preferably 0.1 to 3 wt %, and particularly preferably 0.5 to 2 wt %.

7. Other Additives

Various additives can be included as required, for example, a surfactant for forming a uniform adhesive layer for resin.

The above-mentioned solution for forming an adhesive layer can be prepared easily by dissolving the respective ingredients in water. It is preferable that the water is ion exchange water, pure water, extra-pure water or the like, from which ionic materials and impurities have been eliminated.

In formation of the adhesive layer by using the solution, first, the solution is contacted with the surface of the copper or copper alloy. The copper or copper alloy is not limited particularly as long as it can be adhered to resin. The copper can be shaped variously such as foils (electrolytic copper foil, rolled copper foil), platings (electroless copper plating, electrolytic copper plating), wires, rods, tubes, and plates used for electronic parts such as electronic substrates and lead frames, ornaments and construction materials. The copper can be compounds that contain other elements depending on the objects, and the examples include brass, bronze, cupronickel, arsenical copper, silicon copper, titanium copper, and chromium copper.

The surface of the copper can be smooth. Alternatively, it can be roughened by etching or the like. For example, the surface is roughened preferably by etching in order to obtain an anchoring effect in lamination with resin. In this case, the adhesion to resin is improved further due to the surface geometry of the adhesive layer and also the anchoring effect provided by the roughened copper surface.

There is no particular limitation on the condition for contacting the solution to the copper surface. For example, in a dipping method, the solution and the copper surface can be contacted with each other for not longer than 5 minutes at a temperature of 10 to 70° C., and more preferably in a time of 5 seconds to 5 minutes at a temperature of 20 to 40° C. Thereby, the solution acts on the copper surface, and a metal layer having a special geometry is formed on the copper surface.

The thus formed metal layer on the copper surface typically has a thickness of not less than 20 nm and not more than 1 μm so as to improve remarkably the adhesion between the copper and the resin.

8. Binding of Silane Compound

A silane compound can be bound further by reaction to the surface of the metal layer of the adhesive layer for resin according to the present invention. The method for binding the silane compound is not limited particularly, and the following steps can be applied for example.

a. Type of Silane Compound

The silane compound to be used can be selected suitably depending on the resin. Examples that can be used for epoxy-based resin include: 3-glycidoxypropyltrimethoxysilane; 3-glycidoxypropyltriethoxysilane; 2-(3,4-epoxycyclohexyl)ethyltrimethoxysilane; N-2-(aminoethyl)-3-aminopropylmethyldiethoxysilane; N-2-(aminoethyl)-3-aminopropyltriethoxysilane; 3-aminopropyltrimethoxysilane; 3-aminopropyltriethoxysilane; N-phenyl-3-aminoethyl-3-aminopropyltrimethoxysilane; 3-mercaptopropyltrimethoxysilane; and 3-mercaptopropylmethyldimethoxysilane.

b. Amount of Silane Compound

It is preferable that silane is dropped gradually and slowly in an aqueous solution of acetic acid generally of 0.1 to 1 wt % by stirring so as to prepare an aqueous solution of the silane compound of 0.1 to 10 wt %.

c. Treatment

The method of binding the silane compound to the metal layer is not limited particularly, but the process below can be used for example.

A base on which the metal layer is formed is dipped in the aqueous solution of silane at room temperature. The base is pulled out slowly, drained and dried. Further, it is dried at a temperature of 100 to 120° C. for about 30 minutes so as to bind the silane compound to the surface of the metal layer.

In an alternative method for binding the silane compound, the base with the metal layer formed thereon is dipped in the aqueous solution of silane compound at room temperature, then promptly dried at a temperature of 25° C. to 100° C. for about 5 seconds to about 5 minutes, or preferably for 30 to 150 seconds. Then, excessive silane compound is removed from the metal layer surface by rinsing with water.

In this manner, the silane compound can be adhered uniformly and homogeneously by drying in a short time under a condition where the excessive silane compound would not be bound before rinsing with water.

9. Resin

Examples of resin to be adhered to copper in the present invention include: thermoplastic resins such as acrylonitrile-styrene resin, acrylonitrile-butadiene-styrene resin, fluorine resin, polyamide, polyethylene, polyethylene terephthalate, polyvinylidene chloride, polyvinyl chloride, polycarbonate, polystyrene, polysulfone, polypropylene, liquid crystal polymer, and polyether ether ketone; and thermosetting resins such as epoxy resin, high heat-resistant epoxy resin, modified epoxy resin, phenolic resin, modified polyimide, polyurethane, bismaleimido-triazine resin, modified polyphenylene ether, and modified cyanate ester. These resins can be modified with polyfunctional groups, or the resins can be toughened with fibers such as glass fibers and aramid fibers.

Among the above-described resins, resins with high-glass transition temperature (so-called high-Tg resin) such as high heat-resistant epoxy resin, modified epoxy resin, modified polyimide, bismaleimido-triazine resin, modified polyphenylene ether, and modified cyanate ester, have difficulty in improving the adhesion to copper in general. The present invention can be applied effectively to such resins.

Here, the “high-Tg resin” denotes a resin having a glass transition temperature of 150° C. or higher (measured with TMA)

### EXAMPLES

Hereinafter, the present invention will be specified with reference to Examples. The present invention will not limited to the Examples.

### Example 1

### (1) Surface Treatment and Measurement of Peeling Strength

An electrolytic copper foil was etched by 2 μm with an aqueous solution of sodium persulfate so as to remove a chromate coating or the like provided on a copper foil at the time of production, thereby exposing the clean copper surface. Then, the copper was dipped in an aqueous solution containing: 22 wt % of sulfuric acid, 1.8 wt % of stannous sulfate (Sn²⁺), 5 wt % of nickel sulfate (Ni²⁺), 15 wt % of thiourea, 2 wt % of copper sulfate, 30 wt % of diethylene glycol, and the ion exchange water as remainder, at a temperature of 30° C. for 30 seconds. Later, the copper was rinsed with water and dried.

On one surface of the thus obtained copper foil, a resin with a copper foil for buildup wiring (resin with copper foil ABF-SHC manufactured by Ajinomoto Co., Inc.; glass transition temperature Tg (TMA)=165° C.) was laminated and pressed with heat. The peeling strength of the copper foil in the thus obtained laminate was measured according to JIS C 6481. The results are shown in Table 1.

### (2) Geometry of Metal Layer

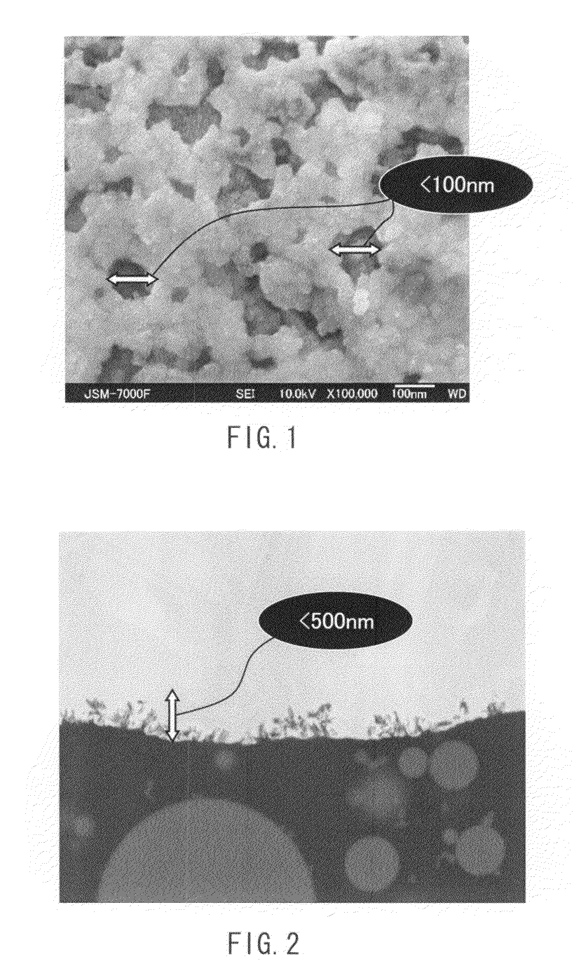

The metal layer had a coralloid structure formed of a number of particles of copper or a copper alloy, and a number of gaps were formed between the particles. Since there were many gaps in the vicinity of the surface of the metal layer, the gaps formed many micropores on the surface of the metal layer. Through an FE-SEM (×100,000), such micropores can be observed on the surface of the metal layer (FIG. 1). The average diameter of the micropores was about 100 nm. The number of the micropores present on the surface of the adhesive layer was about 9 to 10 in the area of 1×1 μm (1 μm²). FIG. 2 shows a cross section of the metal layer observed with an FE-SEM (×20,000). In the observation, the maximum depth of the micropores formed by the gaps among the particles was about 100 to about 500 nm. The metal layer having the structure was made of a copper alloy prepared by mixing copper with small amounts of tin and other metal(s).

### (3) Composition Analysis in Depth Direction of Metal Layer

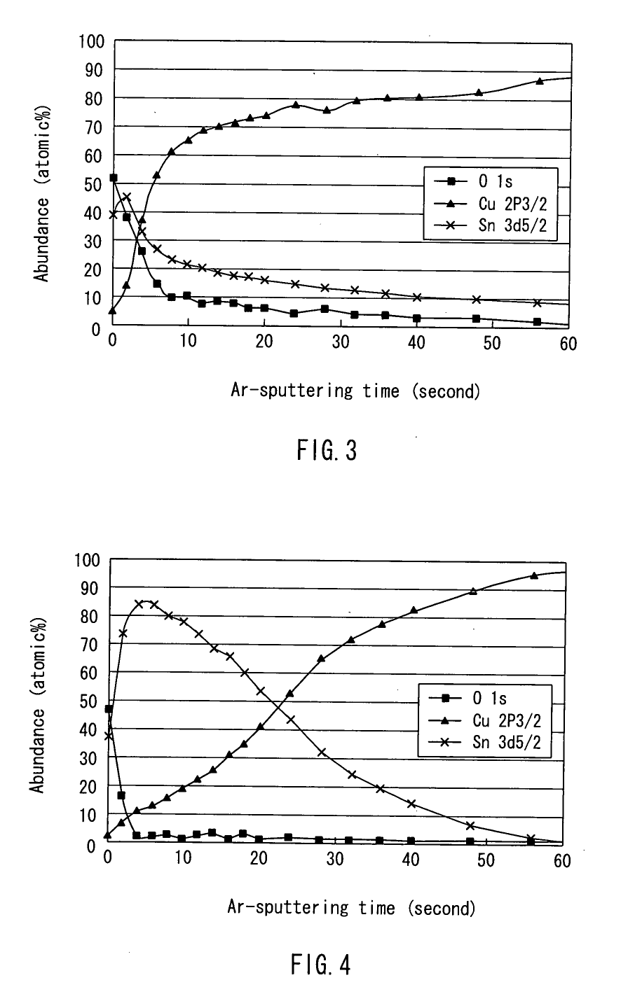

The blend of copper with tin and any other metals is specified below. The copper rate is low relatively in the vicinity of the surface of the adhesive layer, and the copper rate is increased in the deep portion. The metal layer obtained in Example 1 was subjected to a composition analysis in the depth direction with XPS from the surface layer to a position after an Ar-sputtering (up to GO seconds). The results as shown in FIG. 3 are compared with FIG. 4 showing the analysis for a case where tin having a thickness of about 0.05 μm was plated on the copper surface in accordance with Comparative example 1 below. In FIG. 3, the tin content was larger than the copper content on the uppermost surface (Ar-sputtering time: 0 to 2 seconds), but the copper content surpassed at a deeper position after sputtering for more than 10 seconds. Moreover, in FIG. 3, since the oxygen amount with respect to tin in the vicinity of the uppermost surface was large, it can be considered that a large part of the tin existed in the form of oxide. On the other hand, it was found that in FIG. 4, a great amount of tin as metal was contained. The metal layer in the present invention is not limited to a copper alloy, but it can be a copper layer having the above-mentioned geometry.

### Examples 2 and 3

Examples 2 and 3 were carried out as in Example 1 except that the treatment solutions were changed as indicated in Table 1 below. The results are shown in Table 1.

### Comparative Example 1

Comparative example 1 was carried out as in Example 1 except that the treatment solution was changed to an aqueous solution containing: 12 wt % of stannous fluoroborate, 17 wt % of thiourea, 3 wt % of sodium hypophosphite, 23 wt % of phenolsulfonic acid, 2.5 wt % of polyethylene glycol (PEG) 400; and the ion exchange water as remainder. The thickness of the tin plating layer was set to about 0.05 μm. The results are shown in Table 1.

### Comparative Example 2

Comparative example 2 was carried out as in Comparative example 1 except that the temperature was set to 70° C. and the time was set to 10 minutes. The thickness of the tin plating layer was set to about 1 μm. The results are shown in Table 1.

TABLE 1

| | | | Average | Peeling |
|---|---|---|---|---|
| Examples/ | | (weight | number of | strength |
| Com. Exs. | Additive | %) | pores/1 μm² | (Kgf/cm) |
| Ex. 1 | sulfuric acid | 22 | 10 | 1.00 |
| | stannous sulfate | 1.8 | | |
| | nickel sulfate | 5 | | |
| | thiourea | 15 | | |
| | diethylene glycol | 30 | | |
| | copper sulfate | 2 | | |
| | ion exchange water | remainder | | |
| Ex. 2 | acetic acid | 50 | 8 | 1.07 |
| | stannous acetate | 3 | | |
| | silver nitrate | 0.1 | | |
| | thiourea | 10 | | |
| | ethylene glycol | 5 | | |
| | copper chloride | 2 | | |
| | ion exchange water | remainder | | |
| Ex. 3 | hydrochloric acid | 10 | 11 | 1.05 |
| | stannous nitrate | 1 | | |
| | cobalt sulfate | 1.5 | | |
| | 1,3-diethyl-2-thio- | 5 | | |
| | urea | | | |
| | ethylene glycol | 70 | | |
| | copper chloride | 2 | | |
| | ion exchange water | remainder | | |
| Com. Ex. 1 | stannous fluoro- | 12 | 0 | 0.35 |
| | borate | | | |
| | thiourea | 17 | | |
| | sodium hypophos- | 3 | | |
| | phite | | | |
| | phenolsulfonic acid | 23 | | |
| | PEG400 | 2.5 | | |
| | ion exchange water | remainder | | |
| Com. Ex. 2 | Same as Com. Ex. 1 | | 0 | 0.40 |

(Ex.: Example; Com. ex.: Comparative example)

### Example 4

A copper-clad lamination plate with a glass fabric impregnated with epoxy resin (FR4 grade; glass transition temperature Tg (TMA)=125° C.) was prepared by bonding copper foils having a thickness of 18 μm on both faces. The copper foils were sprayed for cleaning with 5 wt % hydrochloric acid for 10 seconds at room temperature. Subsequently, the copper was rinsed with water, and dried.

Next, the plate was dipped in the aqueous solution as in Example 1 at 30° C. for 30 seconds, and then rinsed with water and dried. An aqueous solution of 1 wt % acetic acid was prepared. This solution was stirred, to which 1 wt % of 3-glycidoxypropyltrimethoxysilane was added little by little, and the solution was further stirred for one hour so as to obtain a colorless and transparent solution. In this aqueous solution, the copper-clad plate treated in the above-described manner was dipped and shook for 30 seconds. Then, the plate was pulled out and drained sufficiently. Later, the plate was set in a 100° C. oven directly (without rinsing with water) to be dried for 30 minutes.

For assessing the adhesion between the thus obtained plate and a resin, FR4-grade pre-pregs were placed and laminated on the both faces of the laminate, which was subjected to heat and pressure so as to prepare a laminate. This laminate was applied with a load for 8 hours at 121° C., 100% RH and at 2 atmospheric pressure in a pressure cooker. Then, it was dipped in a melt-solder bath for 1 minute in accordance with JIS C 6481 in order to check peeling (swelling) of the pre-pregs. The results are shown in Table 2.

### Example 5

Example 5 was carried out as in Example 4 except that the silane was changed to 3-aminopropyltrimethoxysilane. The results are shown in Table 2.

### Example 6

A copper-clad plate treated as in Example 4 was dipped in and pulled out from the silane as in Example 4. The plate was dried at 70° C. for 60 seconds, and subsequently rinsed with water of room temperature for 60 seconds, and dried at 70° C. for 60 seconds. The results are shown in Table 2.

### Comparative Example 3

Comparative example 3 was carried out as in Example 4 except that the treatment solution of Example 1 was changed to that of Comparative example 1. The results are shown in Table 2.

TABLE 2

| | Delamination test |
|---|---|
| Example 4 | No peeling |
| Example 5 | No peeling |
| Example 6 | No peeling |
| Com. Ex. 3 | Peeling on the whole surface |

When the laminate of the present invention is a wiring board having the adhesive layer formed on the surface of the conductive layer, the wiring board will have reliability due to its excellent adhesion with, for example, an interlayer insulating resin (pre-preg, electroless plating adhesive, film-like resin, liquid resin, photosensitive resin, thermosetting resin, and thermoplastic resin), solder resist, etching resist, conductive resin, conductive paste, conductive adhesive, dielectric resin, filling resin, and a flexible cover-lay film.

The laminate of the present invention is used preferably, particularly for a buildup substrate for forming vias, using fine copper wirings, electroless/electrolytic copper plating, and conductive pastes such as a copper paste. The buildup substrate can be selected from a batch-lamination system buildup substrate and a sequential type buildup substrate.

The present invention is applied also to a so-called metal-core substrate that includes a copper plate for the core. When the copper plate has a surface of the above-mentioned adhesive layer for resin, the adhesion between the copper plate surface and an insulating resin laminated thereon will be excellent.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. An adhesive layer for resin, comprising copper or a copper alloy and used for adhering a resin to a layer of copper or a copper alloy, wherein
the adhesive layer is formed of metal layer of a coralloid structure made of an aggregation of a number of particles of copper or copper alloy with gaps between the particles, and a plurality of micropores are present on the surface, and
the micropores have an average diameter in a range of 10 nm to 200 nm, and at least two micropores are present in average per 1 μm² of the metal layer surface.

2. The adhesive layer according to claim 1, wherein a silane compound binds further to one surface of the metal layer to be adhered to the resin.

3. The adhesive layer according to claim 1, wherein the metal layer is formed of a copper alloy containing tin of more than 0 weight % and not more than 3 weight %.

4. The adhesive layer according to claim 3, wherein the tin is contained more in the surface portion than in the inner portion of the metal layer.

5. The adhesive layer according to claim 1, wherein the metal layer has a thickness of not less than 20 nm and not more than 1 μm.

6. The adhesive layer according to claim 1, wherein the resin has a glass-transition temperature of not lower than 150° C.

7. The adhesive layer according to claim 1, wherein the resin is an epoxy resin.

8. The adhesive layer according to claim 2, wherein the silane compound is at least one selected from the group consisting of: 3-glycidoxypropyltrimethoxysilane; 3-glycidoxypropyltriethoxysilane; 2-(3,4-epoxycyclohexyl)ethyltrimethoxysilane; N-2-(aminoethyl)-3-aminopropylmethyldiethoxysilane; N-2-(aminoethyl)-3-aminopropyltriethoxysilane; 3-aminopropyltrimethoxysilane; 3-aminopropyltriethoxysilane; N-phenyl-3-aminoethyl-3-aminopropyltrimethoxysilane; 3-mercaptopropyltrimethoxysilane; and 3-mercaptopropylmethyldimethoxysilane.

9. A method of producing a laminate, comprising steps of
forming a metal layer of a coralloid structure made of an aggregation of a number of particles of copper or copper alloy with gaps between the particles, and a plurality of micropores are present on the surface, and the micropores have an average diameter in a range of 10 nm to 200 nm, and at least two micropores are present in average per 1 μm² of the metal layer surface; and
laminating a layer of copper or a copper alloy with a resin layer via the metal layer.

10. The method of producing a laminate according to claim 9, further comprising a step of further binding a silane compound on the surface of the metal layer to be laminated with the resin.

11. The method of producing a laminate according to claim 9, further comprising steps of: applying a solution containing a silane compound on the surface of the metal layer to be laminated with the resin; drying at a temperature of 25° C. to 100° C. for a time not longer than 5 minutes; and rinsing with water for binding the silane compound.

12. The method of producing a laminate according to claim 9, wherein the metal layer is formed of a copper alloy containing tin of more than 0 weight % and not more than 3 weight %.

13. The method of producing a laminate according to claim 12, wherein the tin is contained more in the surface portion than in the inner portion of the metal layer.

14. The method of producing a laminate according to claim 9, wherein the metal layer has a thickness of not less than 20 nm and not more than 1 μm.

15. The method of producing a laminate according to claim 9, wherein the resin has a glass-transition temperature of not lower than 150° C.

16. The method of producing a laminate according to claim 9, wherein the resin is an epoxy resin.

17. The method of producing a laminate according to claim 10, wherein the silane compound is at least one selected from the group consisting of: 3-glycidoxypropyltrimethoxysilane; 3-glycidoxypropyltriethoxysilane; 2-(3,4-epoxycyclohexyl)ethyltrimethoxysilane; N-2-(aminoethyl)-3-aminopropylmethyldiethoxysilane; N-2-(aminoethyl)-3-aminopropyltriethoxysilane; 3-aminopropyltrimethoxysilane; 3-aminopropyltriethoxysilane; N-phenyl-3-aminoethyl-3-aminopropyltrimethoxysilane; 3-mercaptopropyltrimethoxysilane; and 3-mercaptopropylmethyldimethoxysilane.
